(19) United States
(12) Patent Application Publication
(10) Pub. No.: US 2002/0121433 A1
(43) Pub. Date: Sep. 5, 2002

(54) Watertight electrical switch case

(76) Inventor: Matthias Vogt, Montplaisant (FR)

Correspondence Address: YOUNG & THOMPSON, 745 SOUTH 23RD STREET 2ND FLOOR, ARLINGTON, VA, 22202

(21) Appl. No.: 09/921,694

(22) Filed: Aug. 6, 2001

(30) Foreign Application Priority Data
Mar. 2, 2001 (FR) 0102853

(51) Int. Cl. H01H 9/04

(52) U.S. Cl. 200/302.1

(57) ABSTRACT

An electrical switch case permitting the control of an electrical connection between at least one first electrical cable and at least one second electrical cable, includes: a casing, at least one first watertight wall passage and one second watertight wall passage, at least one first terminal holder and one second terminal holder, at least one first watertight switch, a first electrical connection between the first switch and the first terminal holder, and a second electrical connection between the first switch and the second terminal holder.

The present invention relates to the field of commutation, more especially to electrical switch cases intended to permit the control of an electrical connection between at least one first electrical cable and at least one second electrical cable, in external conditions where humidity is greater than normal, or where they are used in a liquid medium or where there is a risk of their becoming wet.

Electrical commutation generally operates in a medium which has a humidity level close or equal to normal, and has a risk of operating abnormally and dangerously in conditions where humidity is greater than normal, or when a liquid is introduced into the switch.

An object of the present invention is to propose a watertight switch case which is intended to control an electrical connection between at least one first electrical cable and at least one second electrical cable.

Another object of the present invention is to propose a watertight switch case which is intended to permit the control of an electrical connection between at least one first electrical cable and a plurality of electrical cables.

Another object of the present invention is to propose a watertight switch case which is shock-resistant, safe and easy to use.

Another object of the present invention is to propose a switch case which permits the use of electric plugs to be limited.

More precisely, the invention comprises an electrical switch case intended to permit the control of an electrical connection between at least one first electrical cable and at least one second electrical cable, characterised in that it comprises:

a casing comprising a rigid wall, which is impervious to liquids, and defining an internal free space,

at least one first watertight wall passage and one second watertight wall passage, which are intended to permit said at least first and second electrical cables respectively to traverse the watertight wall of the casing,

at least one first terminal holder and one second terminal holder, on which are secured, wire to wire, said at least first and second electrical cables respectively,

at least one first watertight switch, which is controllable from outside the casing and secured to the wall thereof, said switch being intended to permit an electrical connection between said first and second electrical cables,

first means of electrical connection between said first switch and said first terminal holder, and

second means of electrical connection between said first switch and said second terminal holder.

According to one advantageous feature, said casing comprises a first part, which has the configuration of an open container, and a second part, which has a configuration complementary to the opening of the first part, said first and second parts being interconnected in a watertight manner.

According to another advantageous feature, said case comprises delayed-action fuse means.

According to another advantageous feature, said first and second means of electrical connection between said at least first switch and said at least first terminal holder and second terminal holder respectively include a printed circuit board, the first and second terminal holders being secured on said board.

According to another advantageous feature, said case comprises at least one electronic indicator, which provides information, visible from outside the case, concerning the state of connection of said at least first electrical cable and second electrical cable.

According to another advantageous feature, said at least first watertight wall passage and second watertight wall passage respectively include first and second means for tightening said first cable and second cable, within a range of predetermined diameters.

According to another advantageous feature, the tightening means respectively comprise a plurality of tongues capable of surrounding a cable, said tongues having free ends capable of converging towards the axis of the cable as a result of pressure being exerted parallel to said cable axis, in order to ensure that said cable is tightened.

According to another advantageous feature, said pressure exerted parallel to said cable axis is ensured by a nut-and-screw system.

According to another advantageous feature, said tongues are distributed regularly over an annular surface intended to surround the cable, said tongues respectively having a cross-section of decreasing thickness towards the interior of the annular surface.

According to another advantageous feature, the case according to the invention is also intended to permit the control of an electrical connection between said first electrical cable and a third electrical cable, fourth electrical cable and a fifth electrical cable, and also comprises:

a third watertight wall passage, a fourth watertight wall passage and a fifth watertight wall passage, which are intended to permit the third electrical cable, the fourth electrical cable and the fifth electrical cable respectively to traverse the watertight wall of the casing,

a third terminal holder, a fourth terminal holder and a fifth terminal holder, on which are secured, wire to wire, the third, fourth and fifth electrical cables respectively,

a second watertight switch, a third watertight switch and a fourth watertight switch, which are controllable from outside the casing and secured to the wall thereof, said switches being intended to control an electrical connection between said first electrical cable and third electrical cable, said first electrical cable and fourth electrical cable, said first electrical cable and fifth electrical cable respectively,

third, fourth and fifth means of electrical connection between said second, third and fourth switches respectively and said first terminal holder, and

sixth, seventh and eighth means of electrical connection between said second, third and fourth switches and said third, fourth and fifth terminal holders respectively.

Other features and advantages of the invention will become apparent on reading the following description of one embodiment of a watertight switch case according to the invention, together with the accompanying drawings, said embodiment being given by way of a non-limiting illustration.

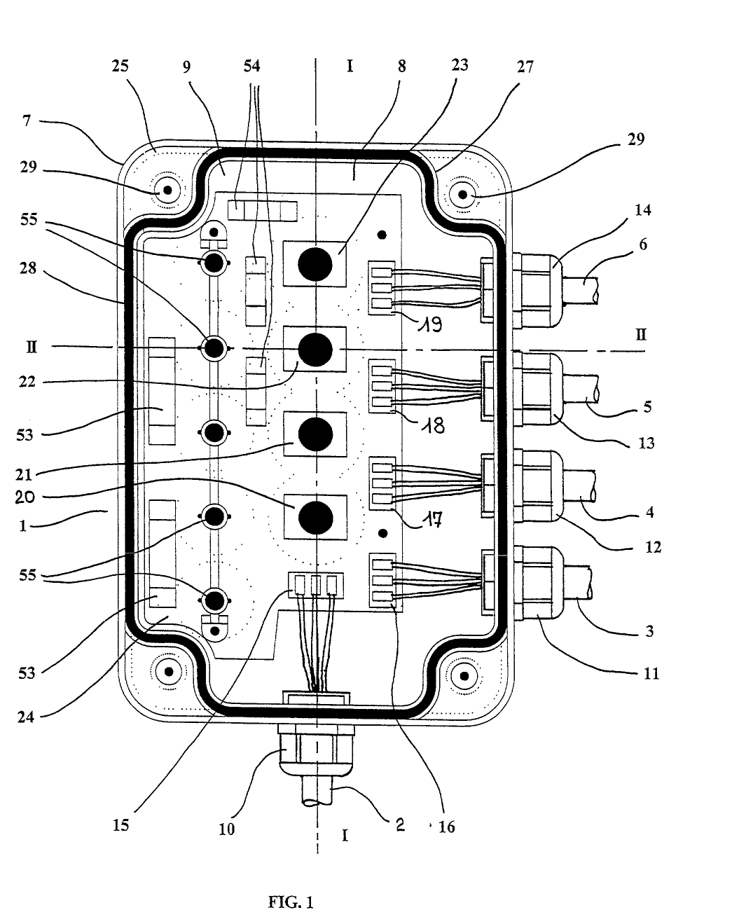

FIG. 1 is a schematic plan view, in partial section, of an embodiment of a watertight switch case according to the invention.

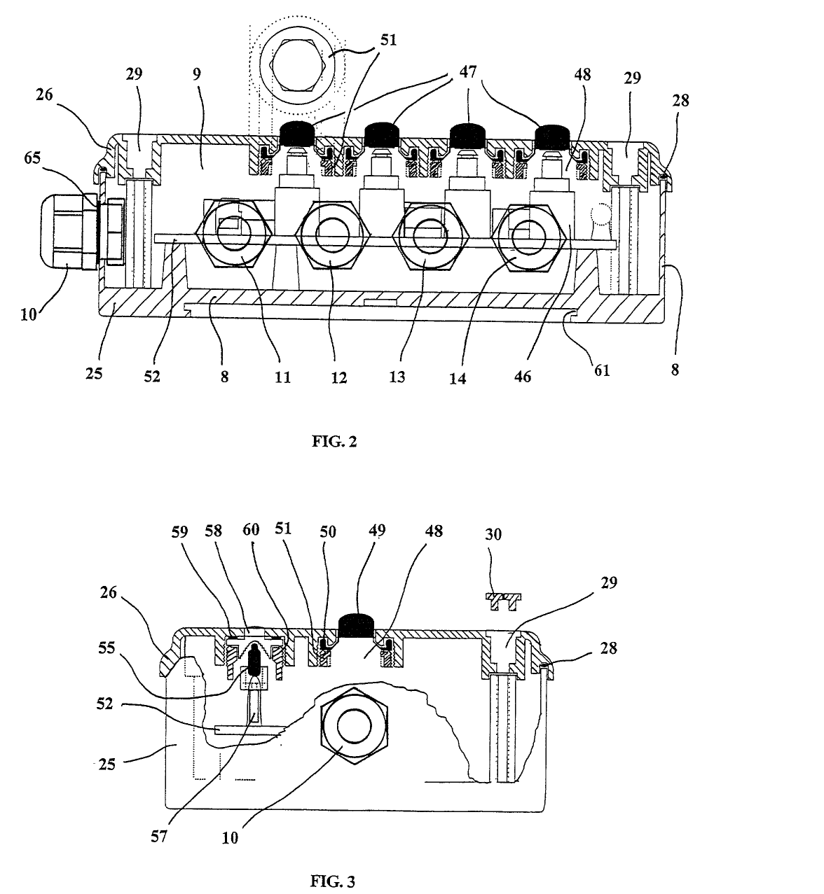

FIG. 2 is a schematic, longitudinal sectional view taken along the line I-I of the embodiment illustrated in FIG. 1.

FIG. 3 is a schematic, partial cross-sectional view, taken along the line II-II of FIG. 1, of the illustrated embodiment.

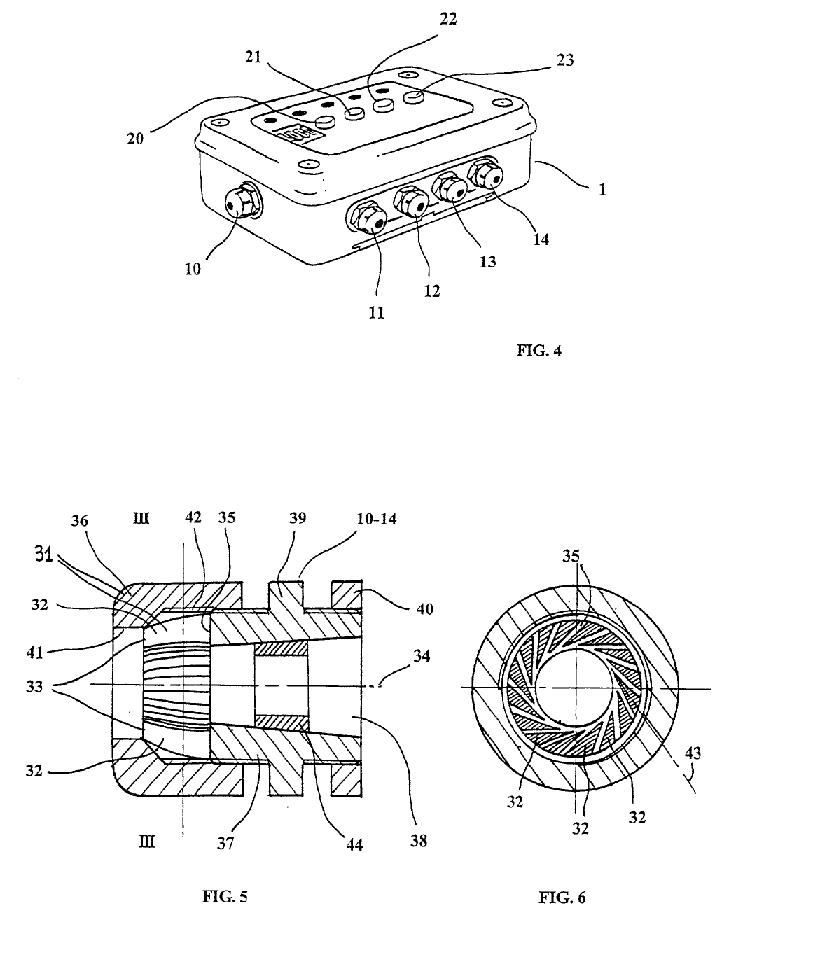

FIG. 4 is a perspective view of the embodiment illustrated in FIG. 1.

FIG. 5 is an enlarged longitudinal sectional view of a detail of the embodiment according to FIG. 1.

FIG. 6 is a cross-sectional view taken along the line III-III of FIG. 5.

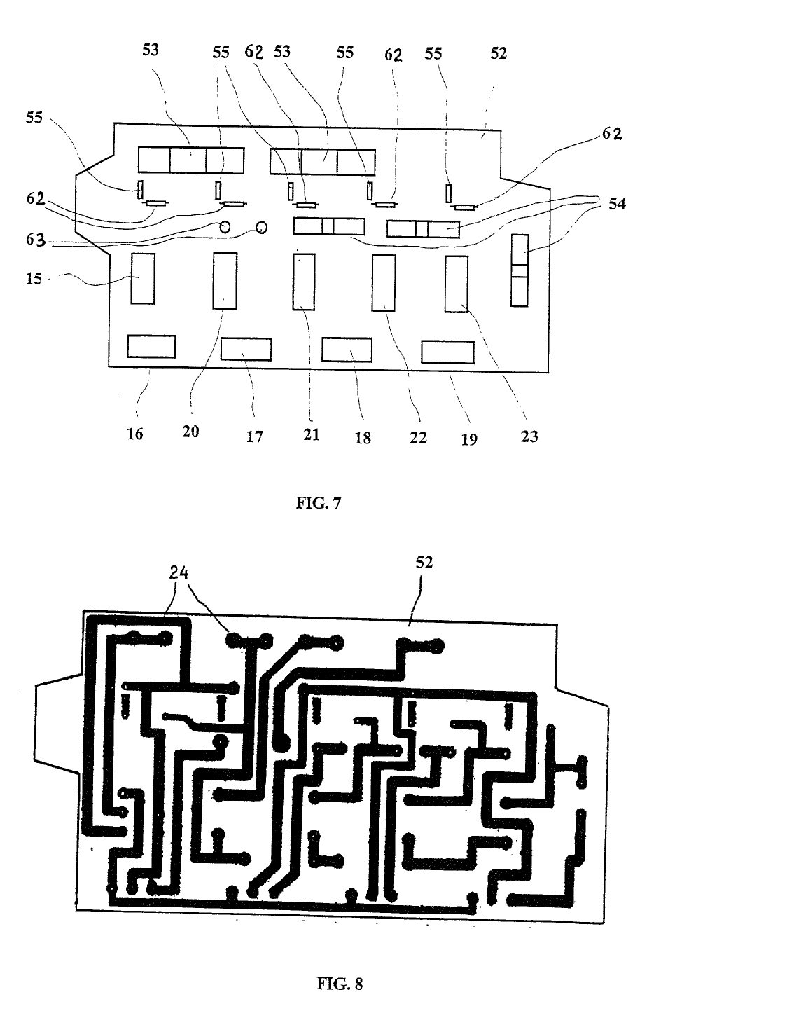

FIG. 7 is a plan view of the printed circuit board provided with components which equip the case illustrated in FIG. 1.

FIG. 8 is a schematic plan view of the electrical printed circuit of the printed circuit board illustrated in FIG. 7.

The watertight electrical switch case 1, illustrated in FIG. 1, is intended to permit the control of an electrical connection between a first electrical cable 2, on the one hand, and a second electrical cable 3, a third electrical cable 4, a fourth electrical cable 5 and/or a fifth electrical cable 6, on the other hand. In order to achieve this object, the case 1 comprises

a casing 7 comprising a rigid wall 8, which is impervious to liquids, and defining an internal free space 9, a first watertight wall passage 10, a second watertight wall passage

a third watertight wall passage 12, a fourth watertight wall passage 13 and a fifth watertight wall passage 14, which are intended to permit the first electrical cable 2, the second electrical cable 3, the third electrical cable 4, the fourth electrical cable 5 and the fifth electrical cable 6 respectively to traverse the watertight wall 8 of the casing 7,

a first terminal holder 15, a second terminal holder 16, a third terminal holder 17, a fourth terminal holder 18 and a fifth terminal holder 19, on which are secured, wire to wire, the first electrical cable 2, the second electrical cable 3, the third electrical cable 4, the fourth electrical cable 5 and the fifth electrical cable 6 respectively, as illustrated in FIG. 1,

a first watertight switch 20, a second watertight switch 21, a third watertight switch 22 and a fourth watertight switch 23, which are controllable from outside the casing 7 and secured to the wall 8 thereof, said switches being intended to permit an electrical connection between the first electrical cable 2 and the second electrical cable 3, between the first electrical cable 2 and the third electrical cable 4, between the first electrical cable 2 and the fourth electrical cable 5, and between the first electrical cable 2 and the fifth electrical cable 6 respectively,

means 24 of electrical connection, respectively:

between the first switch 20 and the first terminal holder 15, on the one hand, and between the first switch 20 and the second terminal holder 16,

between the second switch 21 and the first terminal holder 15, on the one hand, and between the second switch 21 and the third terminal holder 17,

between the third switch 22 and the first terminal holder 15, on the one hand, and between the third switch 22 and the fourth terminal holder 18,

between the fourth switch 23 and the first terminal holder 15, on the one hand, and between the fourth switch 23 and the fifth terminal holder 19.

The casing 7 advantageously comprises a first part 25, which has the configuration of an open container, for example a rectangular parallelepiped, and a second part 26, which has a configuration complementary to the opening 27 of the first part 25, the first part 25 and the second part 26 being interconnected, in a watertight manner, by means of a sealing joint 28 placed between the first part and the second part along the contact surfaces between these two parts, as illustrated in FIGS. 1 to 3.

In FIG. 1, the second part 26 has been removed so as to show the interior of the first part 25. The second part 26 of the casing 7 will be secured, in a detachable manner, on the first part 25 of the casing by means of rust-proof screws (not illustrated), preferably four screws embedded in holes 29 provided for this purpose, as illustrated in FIGS. 1 to 3. It is to be noted that, in FIGS. 2 and 3, the screw holes have been totally or partially moved back in the cross-sectional plane so that these holes may be illustrated. The connections of the two parts 25 and 26 of the casing 7 by screws will either be watertight or be effected so that they do not project into the space 9 inside the casing. A cap 30 may be used to seal the hole 29, permitting a screw to be embedded, for example as illustrated in FIG. 3 where the cap is shown externally of the hole.

The casing 7 may be formed from any watertight material, preferably a material which is electrically non-conductive, rust-proof, non-inflammable and shock-resistant, for example an appropriate plastics material. An acrylonitrile butadiene styrene (ABS) may advantageously be selected for this purpose. In addition, the casing 7 may be provided with all of the means which permit it to be secured on any support whatsoever, for example a wall support; these means may be a groove 61, in which a securing plate (not illustrated), itself secured to said support, would be slidingly engaged.

The first watertight wall passage 10, the second watertight wall passage 11, the third watertight wall passage 12, the fourth watertight wall passage 13 and the fifth watertight wall passage 14 are secured on the lateral walls of the casing 7, the first being on a small side, and the others being on a large side, as illustrated in FIG. 1. The five watertight passages 10, 11, 12, 13 and 14 are identical, formed preferably from plastics material as explained hereinafter and secured, by a nut-and-screw system, in respective holes of the casing provided for this purpose, by means of a sealing joint 65 which is inserted between each passage and the wall of the casing. A passage 10, 11, 12, 13, 14 comprises a cylindrical body 37 traversed by an axial hole 38 for the cable to pass therethrough. The cylindrical body 37 is provided, on its external surface, with a plug means 39 which has the configuration of a flange for a tightening spanner, and a nut 40 screwed to one end of the body in order to permit it to be secured on the wall 8 of the casing 7, clamped between the plug means 39 and the nut 40 and the sealing joint 65. The nut 40 is placed inside the casing 7. At the other end of the body there is an annular end surface 35, provided with means 31 for tightening the cable which traverses it, within a predetermined range of diameters, in order to provide the switch case with a flexibility of use by permitting a passage to tighten electrical cables of different diameters.

As illustrated in FIG. 5, the tightening means 3 1 of a passage 10, 11, 12, 13 or 14 respectively comprise a plurality of tongues 32, capable of surrounding a cable symbolised in FIG. 5 by its longitudinal axis 34 which coincides with the axis of the body of the passage, the tongues 32 having sufficient flexibility, and having free ends 33 capable of converging towards the axis 34 of the cable as a result of a pressure exerted parallel to this axis 34, in order to ensure that the cable is tightened. The base of the tongues is connected to the annular surface 35 of the passage body.

As illustrated in FIG. 6, the tongues 32 are regularly distributed over the annular surface 35, the latter preferably being perpendicular to the axis 34, being intended to surround the cable, and being formed by the end surface of the body 37 of the passage, the tongues 32 respectively having a cross-section of decreasing thickness towards the interior of the annular surface 35 and substantially constant along the longitudinal axis 34. The tongues 32 are made parallel to the axis 34 and remain as such in the state of rest, and their respective free ends 33 must be able to converge towards the axis 34 of the cable under the pressure of a tightening nut 36 engaging on the body 37 of the passage by means of the axial displacement of the nut. For this purpose, the nut 36 comprises, at one end, an internal diameter greater than the diameter of the largest cable which it is desirable to use, and smaller than the external diameter determined by the tongues 32, so as to force the tongues to converge towards the axis 34 when the nut 36 is tightened. When the nut 36 is loosened, the tongues 32 will be able either to resume their initial position of rest if the material from which they are made is sufficiently resilient, or to remain in position and part under a tension of the cable which it would be desirable to remove. The nut 36 will be able to have, internally, a conical surface extending between the cable disengagement hole 41 and the thread 42 for engaging on the body 37, serving to assist the guidance of the deformation of the tongues 32, as illustrated in FIG. 5.

As illustrated in FIG. 6, the respective transverse axis 43 of the tongues, which traverses the annular surface, is substantially orientated along a chord of the annular surface; thus, the orientation of this axis 43, which defines the direction of the easiest deformation of the tongue 32, must be such that the latter will naturally be capable of being deformed towards the axis 34, in order to be able to exert a pressure on the cable. When the tongues 32 move towards the axis 34 as a result of the nut 36, the structure of said tongues, which has been described previously and is illustrated in FIGS. 5 and 6, permits the tightening diameter, defined by the ends 33 of the tongues 32, to be reduced concentrically relative to the axis 34, by sliding the ends 33 over one another, and thereby to permit cables of various diameters to be tightened, for example cables from 4 to 8 mm in diameter. When the tongues move towards the axis 34 as a result of the pressure of the nut 36, the inclination of the transverse axis 43 causes these tongues to be deformed, while they interlock with one another towards their ends 33, thereby providing the assembly of tongues with good rigidity for correctly tightening the cable.

The hole 38 for allowing the cable to pass into the body 37 of the passage will preferably be slightly conical, the large diameter of the cone being placed towards the inside of the casing and the small diameter being placed towards the outside, the small diameter of the cone being greater than the largest diameter of cable to be tightened. A cylindrical sealing ring 44, which has a constant circular cross-section and is formed from resilient material, will be placed inside the hole 38, in order to provide sealing between the external surface of the cable and the internal surface of the hole 38. Depending on the diameter of the cable to be tightened, the ring will be able to be displaced along the conical hole in order to find the appropriate location for correct sealing.

Preferably, the passage will be made from a solid piece of rigid but non-brittle plastics material, the flexibility of the tongues 32 being provided by their respective long length relative to the dimensions of the cross-section. The nuts 40 and 36 of the passage will be inserted by a screwing operation and will be made from the same material as the passage body 37.

The terminal holders 15, 16, 17, 18, 19 are identical and of any known type, and each one has three insulated tightening contacts in order to permit the securement of a cable having three conductive wires and the connection of these wires, the live, the neutral and the earth, for example for the switch case according to the invention to be used in dwellings, shops and offices. The terminal holders may be screw-type terminal holders, and each may include as many connection contacts as there are wires in a cable to be connected.

The watertight switches 20, 21, 22 and 23 are identical, and any type of known watertight switch may be used. Preferably, a watertight switch comprises a conventional switch 46, of the push-in type, secured inside the casing 7, and a watertight cap 47 secured to the wall of the casing 7, permitting an operator to actuate the push-button 46 from outside the case to establish a connection between the electrical cables connected to this push-button. As illustrated in FIGS. 2 and 3, the cap 47 is formed from a flexible watertight cover having a hollow part 49 which is intended to accommodate the push-button 46 and is surrounded by a flange 50 intended to permit the cap 47 to be secured in a hole 48 provided for this purpose on the wall of the casing, more precisely on the second part 26 of the casing. The cap 47 is secured in a watertight manner on the casing 7 by means of a nut 51 compressing the flange against the casing. The hollow part 49 traverses an opening in the casing, which opening is provided for this purpose, and in the axis of which opening there is the push-button 46. The constituent material of the cap 47 will preferably be a synthetic rubber, for example a silicone containing, as the principal component, a silicone-oxygen core, which provides the cap with a high degree of resilience and a good resistance to high and low operating temperatures, more especially from −60° C. to 250° C., for an economical price.

The electrical connection means between the switches and the terminal holders, as described previously, may be advantageously formed from appropriate circuits 24 of all known types, provided on a printed circuit board 52 as illustrated in FIG. 8 for example, which board 52 will serve as a support for all of the electrical components of the case, namely the terminal holders, the switches and other components as described hereinafter. For this purpose, these components will be selected so as to be attachable to a printed circuit. The printed circuit board 52 will be rigidly secured inside the casing on the first part 25 thereof by means of screws (not illustrated).

Preferably, the electrical connections will be protected against short-circuits by means of a plurality of fuses 53 and 54, which are rated according to the maximum permissible voltage and strength on the circuit under consideration. For example, in the case of a 220 volt power supply in the first cable, a fuse of 10 amperes fitted thereto may be envisaged, and fuses of 2.5 amperes for example may be respectively envisaged on the separate outputs (other electrical cables). Preferably, delayed-action fuses will be used.

As illustrated in FIGS. 1 and 3, the watertight switch case advantageously comprises electronic indicators 55 giving information, which is visible from outside the case, concerning the connection state of the electrical cables, that is to say concerning the position of each switch. For this purpose, the case comprises one electronic indicator per switch, namely four in the embodiment illustrated. The electronic indicators will be attached to the printed circuit, possibly by means of a protective support bar 57 secured, for example, to the printed circuit board 52, as illustrated in FIG. 3. This bar 57 permits the conductive wires to be separated physically from the electronic indicators, in order to improve the protection against short-circuits. In order for the electronic indicators to be visible from outside the case, openings will be provided and respectively sealed, in a watertight manner, by an inspection hole 58, which openings permit the desired electronic wavelength or wavelengths to pass therethrough. The inspection holes 58 will be of similar configuration and of different colours or not. Preferably, the electronic indicators are identical and will possibly be differentiated by their respective colour. As with the caps of the switches, the inspection holes will be respectively secured by a nut 60 with, in addition, a sealing joint 59 placed between each inspection hole and the casing or, more precisely, between each inspection hole and the first part 25 of the casing.

FIGS. 7 and 8 show, by way of example, an attachment of the various components which have been described above on the printed circuit board 52, and their electrical connections respectively. The electrical connections are illustrated by a black line in FIG. 8, and have been illustrated on the same side of the board as the components illustrated in FIG. 7, in order to make it easier to read the circuits and to see the correlation with the electrical connections. In FIG. 7, the board comprises resistors 62, calculated according to the electrical characteristics of the electronic indicators 55, if necessary. Reference numerals 63 specify the terminals of an electrical bridge on the board. It is to be noted that the scales of the illustrations in FIGS. 7 and 8 are different, and that these Figures are simple schematic illustrations. Dimensional differences may exist between the two illustrations, but they do not hinder the comprehension of the Figures for the person skilled in the art.

1. Electrical switch case (1) intended to permit the control of an electrical connection between at least one first electrical cable (2) and at least one second electrical cable (3), characterised in that it comprises:
a casing (7) comprising a rigid wall (8), which is impervious to liquids, and defining an internal free space (9),
at least one first watertight wall passage (10) and one second watertight wall passage (11), which are intended to permit said at least first and second electrical cables respectively to traverse the watertight wall of the casing,
at least one first terminal holder (15) and one second terminal holder (16), on which are secured, wire to wire, said at least first and second electrical cables respectively,
at least one first watertight switch (20), which is controllable from outside the casing (7) and secured to the wall thereof, said switch being intended to permit an electrical connection between said first and second electrical cables,
first means of electrical connection between said first switch (20) and said first terminal holder (15), and
second means of electrical connection between said first switch (20) and said second terminal holder (16).

2. Case according to claim 1, characterised in that said casing (7) comprises a first part (25), which has the configuration of an open container, and a second part (26), which has a configuration complementary to the opening (27) of the first part, said first and second parts being interconnected in a watertight manner.

3. Case according to claim 1 or 2, characterised in that it comprises delayed-action fuse means (54).

4. Case according to one of claims 1 to 3, characterised in that said first and second means of electrical connection between said at least first switch (20) and said at least first terminal holder (15) and second terminal holder (16) respectively include a board (52) with a printed circuit (24), the first and second terminal holders being secured on said board.

5. Case according to one of claims 1 to 4, characterised in that it comprises at least one electronic indicator (55), which provides information, visible from outside the case, concerning the state of connection of said at least first electrical cable (2) and second electrical cable (3).

6. Case according to one of claims 1 to 5, characterised in that said at least first watertight wall passage (10) and second watertight wall passage (11) respectively include first and second means (32) for tightening said first cable (2) and second cable (3), within a range of predetermined diameters.

7. Case according to claim 6, characterised in that the tightening means respectively comprise a plurality of tongues (32) capable of surrounding a cable, said tongues having free ends (33) capable of converging towards the axis (34) of the cable as a result of pressure being exerted parallel to said cable axis, in order to ensure that said cable is tightened.

8. Case according to claim 7, characterised in that said pressure exerted parallel to said cable axis is ensured by a nut-and-screw system (42).

9. Case according to claim 7 or 8, characterised in that said tongues (32) are distributed regularly over an annular surface (35) intended to surround the cable, said tongues respectively having a cross-section of decreasing thickness towards the interior of the annular surface.

10. Case according to one of claims 1 to 9, characterised in that it is also intended to permit the control of an electrical connection between said first electrical cable (2) and a third electrical cable (4), a fourth electrical cable (5) and a fifth electrical cable (6), and in that it also comprises:
a third watertight wall passage (12), a fourth watertight wall passage (13) and a fifth watertight wall passage (14), which are intended to permit the third electrical cable (4), the fourth electrical cable (5) and the fifth electrical cable (6) respectively to traverse the watertight wall (8) of the casing,
a third terminal holder (17), a fourth terminal holder (18) and a fifth terminal holder (19), on which are secured, wire to wire, the third, fourth and fifth electrical cables respectively,
a second watertight switch (21), a third watertight switch (22) and a fourth watertight switch (23), which are controllable from outside the casing and secured to the wall thereof, said switches being intended to permit an electrical connection between said first electrical cable (2) and third electrical cable (4), said first electrical cable (2) and fourth electrical cable (5), said first electrical cable (2) and fifth electrical cable (6) respectively,
third, fourth and fifth means of electrical connection between said second, third and fourth switches respectively and said first terminal holder, and
sixth, seventh and eighth means of electrical connection between said second, third and fourth switches and said third, fourth and fifth terminal holders respectively.
